(19) United States
(12) Patent Application Publication
(10) Pub. No.: US 2010/0187264 A1
(43) Pub. Date: Jul. 29, 2010

(54) BEVERAGE CAROUSEL DISPENSING DEVICE SUITABLE FOR TAPPING MULTIPLE SELF-EMPTYING BEVERAGE CONTAINERS

(75) Inventors: Karel Frederik Rethmeier, Eindhoven (NL); Ernest David Jan Sanderse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/601,324

(22) PCT Filed: May 26, 2008
(86) PCT No.: PCT/IB2008/052065

§ 371 Date: Nov. 23, 2009

(30) Foreign Application Priority Data
May 30, 2007 (EP) 07109173.0

(51) Int. Cl. B67D 1/04; B67D 7/06; B65D 83/00

(52) U.S. Cl. 222/394; 222/129; 222/399

(57) ABSTRACT

The present invention relates to a self-emptying beverage container containing a beverage that can be emptied in one go without using gravity or an external pressure source at the time the beverage is being delivered. The present invention further relates to a beverage carousel dispensing device for tapping multiple beverage containers, especially multiple self-emptying beverage containers.

### BACKGROUND OF THE INVENTION

1. Field of the Invention

This invention relates to a self-emptying beverage container containing a beverage. The present invention further relates to a beverage carousel dispensing device for tapping multiple beverage containers, especially multiple self-emptying beverage containers.

2. Description of Prior Art

Beverage containers are widely known in prior art, such as beer cans, beer bottles or kegs.

Beer cans and beer bottles have the drawback that they cannot be emptied in one go without gravity. With respect to beer kegs it is known from prior art to use an external gas pressure source during delivery of the beer. However, a disruption of the external gas pressure feeding stops the delivery of the beer. Further, an external gas pressure source is necessary to deliver the beer if gravity is not used.

Another disadvantage of present beer delivering systems is that air can contact the beer, so that the freshness and taste of the beer is spoiled.

In prior art no self-emptying beer containers are known that can be emptied out in one go without using gravity or an external pressure source at the time the beverage is being delivered.

Further, a beer carousel dispensing device for tapping multiple self-emptying beer containers referred to as beverage carousel dispensing device for receiving self-emptying beer containers that can be emptied out in one go without using gravity or an external pressure source at the time the beverage is being delivered is not described in prior art.

### SUMMARY OF THE INVENTION

It is an object of the present invention to provide a self-emptying beverage container containing a beverage, that can be emptied in one go without using gravity or an external pressure source at the time the beverage is being delivered.

This is obtained with a self-emptying beverage container according to the invention, which comprises:
a beverage outlet opening;
a compressed gas in an amount that is sufficient to drive out the beverage in the self-emptying beverage container in one go;
   wherein the maximum filling level of the beverage of the self-emptying beverage container is ≦90 Vol.-% of the total inner volume of the self-emptying beverage container.

In to the present invention the term “self-emptying beverage container” means that the beverage is not delivered from the beverage container due to gravity. The term “self-emptying beverage container” means that the amount of the compressed gas inside the beverage container is sufficient only to drive out the beverage in one go. In other words there is no need to continuously add gas to the beverage container during the time the beverage is being delivered, since the beverage container is self-emptying due to the gas amount contained inside said beverage container before delivery of the beverage.

In to the present invention the term “non self-emptying beverage container” means that the beverage is delivered by gravity and/or by means of an external gas source that forces the beverage out of the beverage container. The amount of gas in the beverage container is not sufficient to drive out the beverage in one go.

The term “beverage container” as such, without any additional definition, stands for a non self-emptying beverage container and a self-emptying beverage container.

In to the present invention the term “external” means that the gas pressure necessary to drive out the beverage is located spaced apart from the beverage container or beverage located in the beverage container.

### DETAILED DESCRIPTION OF THE INVENTION

Before the invention will be described in detail, it is to be understood that this invention is not limited to the particular component parts of the devices described or process steps of the methods described, as such devices and methods may vary. It is also to be understood that the terminology used herein is for the purpose of describing particular embodiments only, and is not intended to be limited. It must be noted that, as used in the specification and the appended claims, the singular forms “a,” “an” and “the” include singular and/or plural references unless the context clearly indicates otherwise.

The use of a self-emptying beverage container according to the present invention has the benefit that there is no need of using gravity as well as an external gas pressure source to deliver the beverage at the time of consumption by a consumer.

Another benefit of the self-emptying beverage container according to the present invention is that said self-emptying beverage container can be used with a beverage dispensing device that has no external gas pressure source.

It may be preferred that the self-emptying beverage container is a single-portioned beverage container.

In the present invention the term “single-portioned” means that the container contains the beverage in an amount of ≧200 ml and ≦1000 ml, preferably ≧300 ml and ≦500 ml and most preferably 330 ml.

The self-emptying beverage container according to the present invention can comprise the beverage in an amount of ≧200 ml to ≦10 l, preferably ≧300 ml to ≦6 l, further preferably ≧500 ml to ≦5 l and more preferably ≧700 ml to ≦3 l. Thus, a single-portioned beverage container according to the present invention contains the beverage amount for a typical single drink.

The amount of gas as well as the gas pressure inside the self-emptying beverage container has to be selected such, that it is sufficient to drive the beverage out of the beverage container in one go. Thus, the self-emptying beverage container according to the present invention can comprise an amount of gas in the self-emptying beverage container, calculated on the basis of atmospheric pressure and room temperature, that is at least ≧1.1 and ≦10, preferably ≧1.3, further preferably ≧1.5, more preferably ≧2 and most preferably ≧3 times as much compared to the total inner volume of said self-emptying beverage container.

For safety reasons the pressure of the compressed gas at room temperature, i.e. 23° C., inside the self-emptying beverage container according to the present invention may be preferred to be at least 1.5 bars, preferably ≧2 bars and ≦10 bars, more preferably ≧3 bars and ≦7 bars and most preferably ≧4 bars and ≦5 bars.

The self-emptying beverage container comprises beverage and a compressed gas. The ratio of the beverage to the compressed gas inside the beverage container should be adjusted such, that the volume amount of beverage inside the beverage container is larger than the volume of the gas inside said beverage container.

The filling level of the beverage of the self-emptying beverage container may be ≧10 vol.-% and ≦90 vol.-%, preferably ≧20 vol.-% and ≦85 vol.-%, also preferably ≧30 vol.-% and ≦70 vol.-% and more preferably ≧40 vol.-% and ≦60 vol.-%, based on the total inner volume of the self-emptying beverage container.

It may be preferred that the volume of the compressed gas inside the beverage container is less than 50 vol.-% and ≧5 vol.-%, preferably ≦40 vol.-% and ≧10 vol.-%, more preferably ≦35 vol.-% and ≧15 vol.-% and most preferably ≦30 vol.-% and ≧20 vol.-%, based on the total inner volume of the self-emptying beverage container.

According to the present invention, the self-emptying beverage container can comprise a gas compartment separated from the beverage compartment in said beverage container. Opening by for example piercing the gas compartment releases the compressed gas, so that the beverage can be delivered from the beverage container.

For example, the compressed gas can be in direct contact with the beverage and/or the compressed gas can be stored in a capsule enclosed in the inner volume of said self-emptying beverage container, whereby the capsule releases a compressed gas stored in said capsule by the time the gas pressure in the self-emptying beverage container falls below a defined gas pressure limit, which is above atmospheric pressure.

A self-emptying beverage container according to the present invention needs at least one beverage opening, so that beverage can be driven out of said container by means of gas pressure. Further, to secure that the gas cannot escape, a beverage delivering tube extends inside said self-emptying beverage container from the beverage opening to the bottom of said upright standing self-emptying beverage container. Due to expansion of the compressed gas the beverage inside the beverage container is forced through the beverage delivering tube out of the container.

A preferred embodiment of the self-emptying beverage container according to the present invention comprises a gas pressure inlet opening through which a compressed gas can be inserted into the self-emptying beverage container; preferably the gas pressure inlet opening and the beverage outlet opening are located opposite each other on the top or bottom of said self-emptying beverage container. More preferably the gas pressure inlet opening and the beverage outlet opening are located near the top or bottom of said self-emptying beverage container. However, most preferably the gas pressure inlet opening and the beverage outlet opening are part of the same valve.

Further, the self-emptying beverage container comprises a beverage delivering tube arranged at least inside the beverage and in contact with the beverage outlet opening arranged on top of the upright standing self-emptying beverage container through which the beverage is driven out, preferably the beverage delivering tube extending to or near the bottom of said self-emptying beverage container.

In order to facilitate a connection with the tapping device, it may be preferred that the beverage outlet opening is arranged in the middle on top of the upright standing self-emptying beverage container.

The beverage outlet opening and/or the outlet opening of the beverage delivering tube may comprise an adapter and/or valve to which the tapping device can be connected in order to deliver the beverage. The connecting element—also called adapter here—may comprise a screw thread, a snap fit and/or a push fit fastening.

The tapping device may comprise a beverage tube. It may be preferred that the tapping device and/or the beverage tube of the tapping device comprises an adapter and/or a valve to which the beverage outlet opening and/or the outlet opening of the beverage delivering tube can be connected.

Further, the tapping device may have a knob for moving an adapter of the tapping device up and down. This has the benefit that the end part of the beverage outlet opening can be easily connected therewith.

In order to reduce the foam formation of a carbonated beverage, such as beer, the tapping device may have a pressure reducing valve and/or a pressure reducing chamber, also referred to as pressure release chamber. Preferably, the tapping device may comprise a pressure release chamber and/or a beverage tube.

In particular for home applications the requirements of hygiene are strict. Therefore, it is an improvement of the beverage container of the present invention that the beverage supply tube may be an integrated part of the beverage container and is disposable after use. Further, it may be preferred that the beverage supply tube has a lower section that extends inside said self-emptying beverage container and an upper section that extends outside said beverage container. The outer upper section of the beverage supply tube can be lead through an inner channel of the tapping device, so that the beverage does not contact the tapping device.

It may be preferred that at least the upper section of the beverage delivering tube is flexible. The flexible tube section can be squeezed by actuating the tapping device, so that, for example by actuating the handle of the tapping device, a beverage flow can be stopped or forced.

The beverage tube may be connected with the beverage container in a gas and liquid tight manner, so that beverage cannot leak from the beverage outlet opening of the self-emptying beverage container.

The beverage delivering tube of said self-emptying beverage container may comprise a sealing means at its outer end opening, which has to be removed, cut, pierced and/or screwed off for opening. This allows a low vertical range of manufacture. Further, it is secured that the self-emptying beverage container according to the present invention can be kept closed until the time of use, which guarantees freshness and tastiness of the beverage.

The self-emptying beverage container may, though this is not preferred, comprise a gas pressure inlet opening and/or a gas pressure inlet tube, which may comprise an adapter so that the container can be connected with a gas supply source for building up the necessary gas pressure. Therefore, it is possible for the gas pressure inlet opening to comprise a connecting element to which a gas pressure supply tube can be connected, wherein the connecting element—also called adapter here—preferably comprises a screw thread, a snap fit and/or a push fit fastening.

It may be preferred that the gas pressure inlet opening is located centrally on top of the paper-based beverage container according to the present invention.

However, in order to provide a low vertical range of manufacture, it is preferred that the self-emptying beverage container has no gas pressure inlet opening and/or gas pressure inlet tube.

The beverage is preferably a carbonated beverage and most preferably beer.

The compressed gas as used according to the present invention can be selected from the group comprising air, nitrogen, carbon dioxide and/or a noble gas, and preferably a mixture of at least two different gases. However, carbon dioxide may be preferred most. Further, the use of a mixture of different gases may be preferred. The gas or the gas mixture can be a gas that has no interaction with the beverage, i.e. it will not detrimentally affect the freshness or tastiness of the beverage. Further, a gas or gas mixture may be preferred that is not or slightly mixable with the beverage.

The gas inside a capsule may be compressed air, since the gas is released in one go from the capsule to force out the beverage from the beverage container such as beer, so that the beverage may be consumed immediately after. Thus, there is no risk of the beverage being spoilt by the released air. The capsule keeps the compressed air inside, so that the air cannot contact the beverage until the time of opening of the beverage container to release the beverage in one go.

Depending on the pressure inside the beverage container it may be preferred to use nitrogen, because carbon dioxide is soluble in the beverage and causes sparkling of the beverage. Thus, for non-sparkling beverages the gas carbon dioxide cannot be used but nitrogen or air. However, air contains oxygen which has the drawback of affecting the freshness and flavor of the beverage. Thus, nitrogen or carbon dioxide or a mixture of nitrogen and carbon dioxide is preferably used as pressure gas.

If a mixture of nitrogen and carbon dioxide is used it may be preferred that the amount of nitrogen [mol] is higher than the amount of carbon dioxide [mol] in the beverage container. Further, it may be preferred that the ratio of nitrogen to carbon dioxide is 10:1 to 1:10 and preferably 5:1 to 1:5.

Another aspect of the present invention is related to a beverage carousel dispensing device for tapping multiple beverage containers, the device comprising multiple self-emptying beverage containers and/or non self-emptying beverage containers.

The beverage carousel dispensing device according to the present invention has a housing, in which a holding element is located for receiving, securing and holding at least two beverage containers comprising non self-emptying beverage containers and/or self-emptying beverage containers according to the present invention, in which the beverage carousel dispensing device comprises a tapping device for dispensing beverage from the beverage container and a cooling element, so that the housing functions as a chiller for cooling the beverage.

The beverage carousel dispensing device according to the present invention allows the consumer for example to store a number of different types of beverages in the beverage carousel dispensing device according to the present invention, so that the consumer may choose between different beverages such as beer. Thus, a beer dispensing carousel device is most preferred according to the present invention.

In general, the present invention provides at least three alternative embodiments of the beverage carousel dispensing device.

The first alternative embodiment of the beverage carousel dispensing device according to the present invention can be used for multiple self-emptying beverage containers only. Such beverage carousel dispensing device is suitable for receiving at least two self-emptying beverage containers. Further, the beverage carousel dispensing device possesses no external gas pressure sources, since the self-emptying beverage containers contain sufficient gas to drive out the beverage in one go.

The second alternative embodiment of the beverage carousel dispensing device according to the present invention can be used for multiple non self-emptying beverage containers only. Such a beverage carousel dispensing device is suitable for receiving at least two non self-emptying beverage containers. In order to drive the beverage out of the non self-emptying beverage containers, the beverage carousel dispensing device needs an external gas pressure source.

The third alternative embodiment of the beverage carousel dispensing device according to the present invention can be used for multiple self-emptying beverage containers as well as for multiple non self-emptying beverage containers. Such a beverage carousel dispensing device is suitable for receiving at least two beverage containers. In order to drive the beverage out of the non self-emptying beverage containers, the beverage carousel dispensing device needs to have an external gas pressure source.

The external pressure source may be a gas capsule and/or a gas pump. It may be preferred that the gas pump is a manually actuated gas pump, for example an air pump, to generate the gas pressure needed to drive the beverage out of the beverage container.

According to the present invention a beverage carousel dispensing device with a housing and a holding element is located within the housing for receiving, securing and holding at least two beverage containers comprising non self-emptying beverage containers and/or self-emptying beverage containers according to the present invention, in which the beverage carousel dispensing device comprises a tapping device for dispensing beverage from the beverage container and a cooling element, so that the housing functions as a chiller for cooling the beverage.

Beverage dispensing devices are disclosed for example in WO 2005113345, WO 9911561 and EP 1298088 A1, which are incorporated herein by reference.

The beverage carousel dispensing device according to the present invention can be provided with a cooling chamber that can be closed with a lid. At least two beverage containers can be placed in the cooling chamber.

In case of a non self-emptying beverage container, each container is provided with a gas pressure inlet opening that is connectable to a connecting element of the gas pressure line from the external gas source. On closure of the lid the connecting element of the gas pressure inlet opening of a non self-emptying beverage container can be brought into engagement in a tight grip with the gas pressure connecting element of the gas pressure line, which can be located in the lid, so that locking the lid may lead to a gastight connection.

According to a preferred embodiment, the beverage carousel dispensing device according to the present invention may comprise a pressure pump, which can be manually actuated to increase the gas pressure inside the self-emptying beverage container arranged at the connecting tapping point, whereby the pressure line of the pump is connected with the gas pressure inlet opening of the beverage container at the connecting tapping point.

The beverage carousel dispensing device according to the present invention may comprise a top cover and/or door, which is connected with the pump, whereby opening or closing of the top cover and/or door actuates the pump. Preferably at least one forward and backward movement of the top cover and/or door actuates a gas pressure stroke from the pump sufficient to empty a beverage container connected therewith in one go.

However, a beverage carousel dispensing device according to the present invention, which is used for self-emptying beverage containers only does not need a pump, so that in this case the vertical range of manufacture can be kept low.

The holding element is located within the housing of the beverage carousel dispensing device according to the present invention for receiving at least two beverage containers.

In general, the holding element receives and/or holds the beverage containers.

The holding element can be actuated, for example manually or via an electrical actuator, to transport a beverage container to a predetermined position. The holding element can comprise arms for holding the beverage containers and/or a conveyor belt for transporting the beverage containers.

According to the present invention it may be preferred that the holding element receives, secures and/or holds at least 4 to 10 beverage containers, preferably self-emptying beverage containers. However, it is also possible for the holding element to receive, secure and/or hold more than 10 beverage containers, for example ≧10, ≧16 or ≧20 beverage containers.

The holding element is mounted movably within the housing of the beverage dispensing carousel device according to the present invention. Preferably, the holding element is mounted pivotably or shiftably with said housing. Thus, the holding element can be actuated to transport a beverage container to a predetermined position, also referred to as connecting tapping point, inside the beverage dispensing device. At the connecting tapping point the beverage container can be connected with the tapping device in order to deliver the beverage.

However, according to the present invention it may be most preferable for the holding element to be rotatable to transport the selected self-emptying beverage container to the predetermined connecting tapping point inside the housing.

According to a preferred embodiment of the present invention, actuation of the holding element replaces a beverage container at the connecting tapping point by another beverage container. This has the benefit that a consumer can replace an empty beverage container with another one and/or can change the beer brand.

In more detail, the holding element within the beverage carousel dispensing device according to the present invention can be actuated to transport a selected beverage container, preferably a self-emptying beverage container, to a predetermined connecting tapping point inside the housing to be connected to the tapping device, so that a first beverage container can be replaced at the connecting tapping point by a second beverage container.

Further, it may be preferred that the beverage carousel dispensing device according to the present invention has a transparent window to check the beer brand of the beverage container at least at the connecting tapping point.

For serving the beverage, the beverage container can be connected with the tapping device. For example, a beverage tube that extends from the beverage container can be lead through a channel of the tapping device. Actuating the handle of the tapping device opens or closes the beverage tube. For example, the beverage tube can be squeezed tight if the tapping device is in a closed position and opened if the tapping device is in an open position.

However, it may be preferred that the beverage tube that extends outside the beverage container comprises a valve that can be closed and opened by an actuation of the tapping device. It may be preferred that the tapping device has a handle that can be manually actuated by a consumer. However, it may also be preferred that the beverage flow can be started and/or stopped by actuating an on/off switch.

Further, the beverage container may have an adapter at the outer end of said beverage tube and/or arranged at the beverage opening. The adapter can be connected with the tapping device to deliver the beverage.

For example, on closure of the lid, the adapter, also referred to as connecting element, of the beverage opening can be brought into engagement in a tight grip with a connecting element of a beverage line of the tapping device, which can be located in the lid, so that locking the lid may lead to a liquid and gas-tight connection.

Additional details, features, characteristics and advantages of the object of the invention are disclosed in the dependent claims. The figures and the following description of the respective figures and examples shows by way of example preferred embodiments of a self-emptying beverage container and of a beverage carousel dispensing device according to the invention.

### BRIEF DESCRIPTION OF THE DRAWINGS

FIG. 1 is a self-emptying beverage container;

FIG. 2a is a beverage-filled self-emptying beverage container;

FIG. 2b is an almost empty self-emptying beverage container;

FIG. 3 is a self-emptying beverage container with a pressure capsule inside;

FIG. 4 is a beverage carousel dispensing device for self-emptying beverage containers;

FIG. 5 is a beverage carousel dispensing device with a manually actuated gas pump with a closed lid;

FIG. 6 is a beverage carousel dispensing device of FIG. 6 with an open lid;

FIG. 7 is a top view of a circular arrangement of a beverage container.

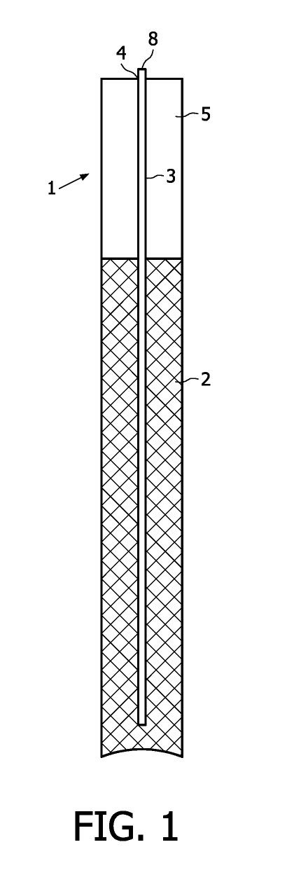

FIG. 1 shows a self-emptying beverage container 1 according to the present invention, containing a beverage (2), such as beer. The self-emptying beverage container 1 comprises a beverage outlet opening (4) that receives a beverage delivering tube (3) with an opening (8) through which the beverage is delivered from said self-emptying beverage container 1. The self-emptying beverage container (1) contains a compressed gas (5) in an amount that is sufficient to drive out the beverage (2) in one go. The filling level of the beverage (2) inside the self-emptying beverage container (1) is about 70 Vol.-% and the dead volume containing the compressed gas is about 30 Vol.-%. It is preferred that the compressed gas is a mixture of carbon dioxide and nitrogen. However, the amount of carbon dioxide is selected such that the taste and carbonation of the beverage, such as beer, is equivalent to a common carbonated beverage of the same type.

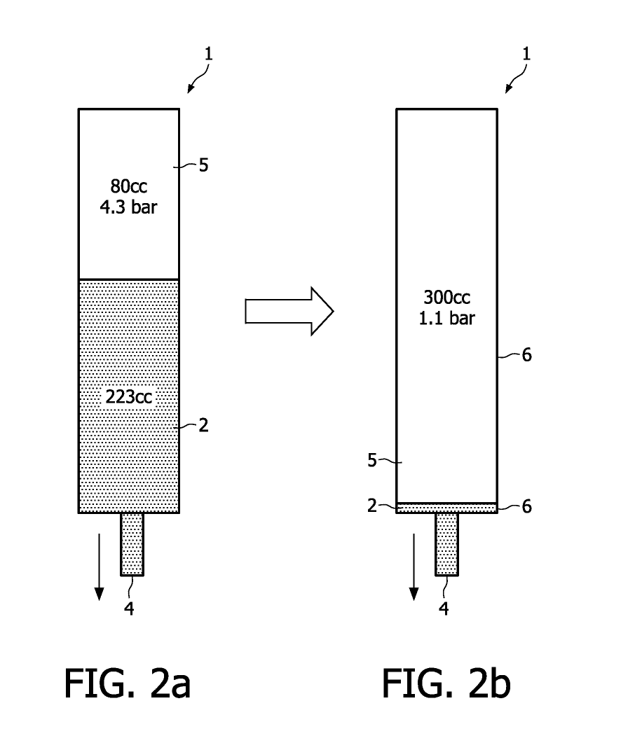

FIG. 2a shows a self-emptying beverage container (1) with a total inner volume (6) of 303 ml. The dead volume of about 80 ml comprises a compressed gas (5) with a pressure of about 4.3 bars at room temperature (room temperature=23° C.). The filling level of the beverage (2) inside the self-emptying beverage container (1) is about 223 ml. The beverage outlet opening (4) is arranged on the bottom of self-emptying beverage container (1). As can be seen in FIG. 2a, the amount of gas inside the self-emptying beverage container (1) is sufficient to empty said beverage container in one go without the need of gravity.

FIG. 2b shows the same self-emptying beverage container (1) as shown in FIG. 2a. The self-emptying beverage container (1) differs from that of FIG. 2a in that the inner gas volume of the compressed gas (5) has been expanded to about 300 ml, which means that the self-emptying beverage container (1) is almost empty. The remaining gas pressure inside said beverage container is about 1.1 bars and sufficient to completely drive out the beverage, such as beer (2), through the beverage outlet opening (4).

In FIGS. 2a and 2b a gas volume is situated above the upper surface of the beverage and contacts same.

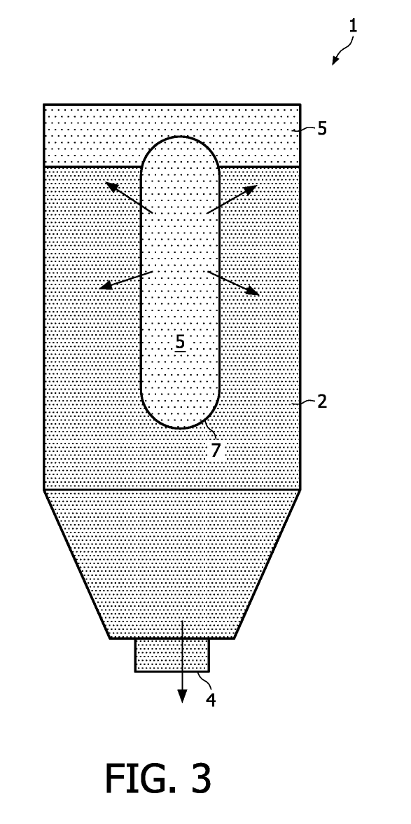

FIG. 3 shows a self-emptying beverage container with a gas pressure capsule (7) inside. The compressed gas (5) is inside said gas pressure capsule (7). Said capsule (7) releases the compressed gas stored inside said capsule (7) by the time the gas pressure inside the self-emptying beverage container falls below a defined gas pressure limit, which is above atmospheric pressure. The gas pressure capsule (7) may have a porous structure and/or a valve in order to release the pressurized gas therein. Due to the expansion of the pressurized gas, the beverage is delivered through the beverage opening (4). The beverage opening (4) can be connected via a beverage tube or line to a tapping device (not shown). The beverage opening (4) may preferably comprise an adapter which can be connected with a tapping device in a liquid and gas tight manner. It is clear, that the beverage opening (4) of the self-emptying beverage container (1) is closed until the time of use, i.e. it is opened for example at the time of connection with a tapping device.

For example, the beverage inside the self-emptying beverage container (1) may be beer and the pressurized gas inside the capsule (7) may be carbon dioxide. The opening of the valve (not shown) can be adjusted so that the gas release is sufficient to drive out the beverage without increasing the carbonation of the beverage to a level that is not accepted by the consumer.

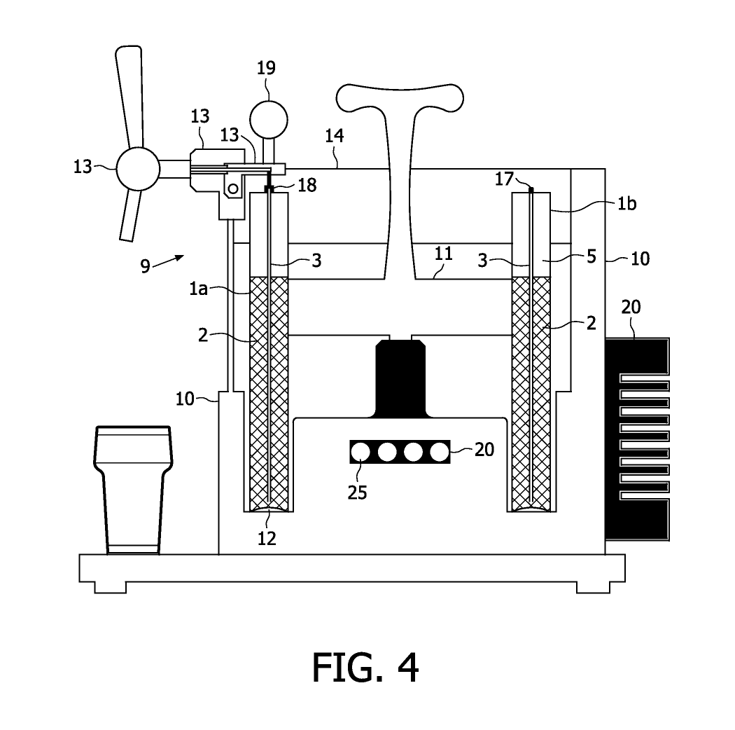

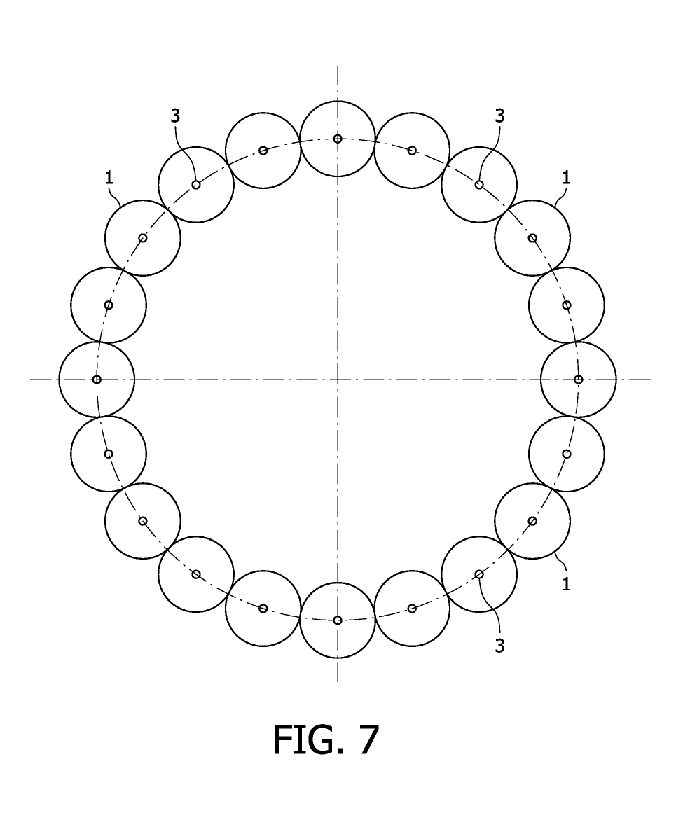

FIG. 4 shows a beverage carousel dispensing device (9) with a housing (10). The housing (10) is closed with a top lid (14) that can be opened to replace the beverage containers (1). Instead of an openable top lid the beverage carousel dispensing device (9) can have a front door (not shown). A holding element (11) is located within the housing (10) for receiving, securing and holding at least two self-emptying beverage containers (1). However, the holding element (11) may receive, secure and/or hold for example up to 20 beverage containers, preferably self-emptying beverage containers (1), as shown in FIG. 7. The holding element (11) has a handle that extends from the housing (10) of said beverage carousel dispensing device (9). The handle can be actuated by the consumer to rotate the holding element (11) in order to transport a selected beverage container, preferably a self-emptying beverage container (1), to a predetermined connecting tapping point (12) inside the housing (10), to be connected to the tapping device (13), so that a first beverage container (1a) can be replaced at the connecting tapping point (12) by another beverage container (1b). The beverage carousel dispensing device (9) comprises a tapping device (13) for dispensing beverage from the self-emptying beverage container (1) and a cooling element (not shown), so that the housing (10) functions as a chiller for cooling the beverage. The cooling system (20) comprises a Peltier element and a channel system through which a coolant flow (25) is circulated.

As can be seen in FIG. 4 an adapter (18) is arranged at the top opening of the beverage delivering tube (3) of the self-emptying beverage containers (1b) which adapter seals the outer end part of the beverage delivering tube (3) and the adapter (18) of the self-emptying beverage container (1a) is connected to the tapping device (13). Connecting the tapping device (13) with the adapter (18) of the self-emptying beverage container (1a) opens the adapter (18) for delivering the beverage. Thus, the adapter (18) functions as a sealing element only. This means, that piercing and/or cutting opens the adapter of the top opening of the beverage delivering tube (3). For example, the adapter, also referred to as connecting element, of the tapping device (13) opens the adapter (18) as a result of a piercing and/or cutting action.

The tapping device (13) can have a knob (19) for moving the adapter (18) of the tapping device (13) up and down.

According to a further embodiment of to the present invention (not shown), the adapter of the beverage delivering tube (3) of the self-emptying beverage container (1) may have a vale function, which opens or closes the top opening of the beverage delivering tube (3). This has the benefit that an almost empty self-emptying beverage container (1) can be replaced without a loss of gas pressure.

However, most preferred is a self-emptying beverage container and/or non self-emptying beverage container with a beverage delivering tube that has an inner section that extends from the bottom of said beverage container to the top opening and an external section that extends outwardly from the top opening. The outer part of said beverage delivering tube can be lead through the tapping device. This has the benefit, that for reasons of hygiene, the tapping device as such is not contaminated with the beverage and need not be cleaned. Further, each beverage container has its own beverage delivering tube, so that the beverage delivering tube need not be cleaned either. A beverage container of this kind has already been described before.

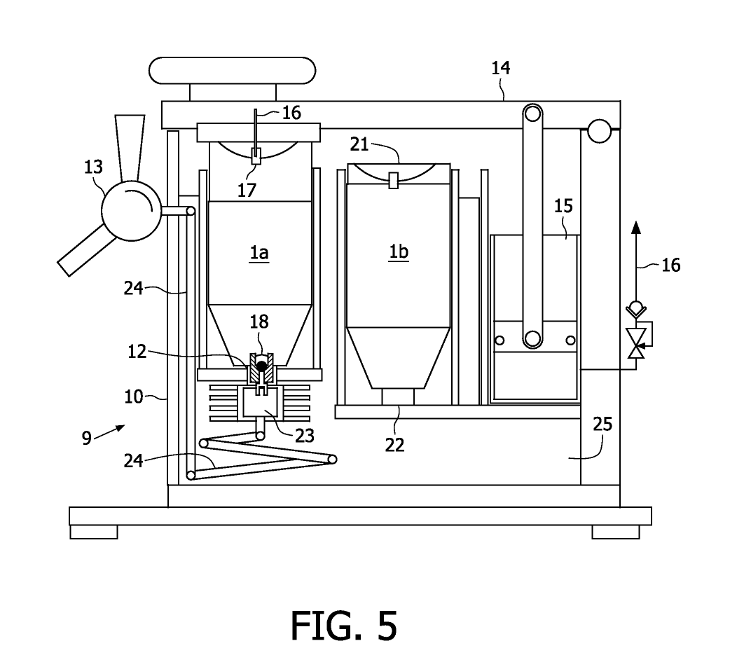

FIG. 5 shows a beverage carousel dispensing device (9) with a housing (10). The housing (10) is closed by a top lid (14) that can be opened to replace the beverage containers (1). A holding element (not shown) is located in the housing (10) for receiving, securing and holding at least two non self-emptying beverage containers (1a, 1b). However, the holding element (11) may receive, secure and/or hold for example up to 20 beverage containers, preferably self-emptying beverage containers (1), as shown above in FIG. 7. The holding element (11) (not shown) has a handle that extends from the housing (10) of said beverage carousel dispensing device (9). The handle can be actuated by the consumer to rotate the holding element (11) in order to transport a selected non self-emptying beverage container (1), to a predetermined connecting tapping point (12) inside the housing (10) to be connected to the tapping device (13), so that a first beverage container (1a) can be replaced at the connecting tapping point (12) by another beverage container (1b).The beverage carousel dispensing device (9) comprises a tapping device (13) for dispensing beverage from the non self-emptying beverage container (1). Further, the beverage carousel dispensing device (9) comprises a cooling element (not shown), so that the housing (10) functions as a chiller for cooling the beverage. The beverage carousel dispensing device (9) of FIG. 5 further comprises a pressure pump (15), which can be manually actuated in order to increase the gas pressure inside the non self-emptying beverage container (1) at the connecting tapping point (12), whereby the pressure line (16) of the pump (15) is connected with the gas pressure inlet opening (17) of the non self-emptying beverage container (1) at the connecting tapping point (12). Opening and closing of the top lid (14) actuates the gas pressure pump (15). The beverage is delivered from the beverage container (1) through the connecting tapping point (12), a chamber (23) and a beverage tube (24), which are completely surrounded by a coolant, which may be ice-water and/or the coolant is cooled by a cooling element (not shown), which may be a Peltier element as shown in FIG. 4. Thus, the cooling system of FIG. 5 works as a “flow-through” cooler for cooling the beverage.

FIG. 5 shows that a valve adapter (18) engages gas and liquid at the beverage opening (4) of a non self-emptying beverage container (1). The flow path of the valve adapter (18) is connected with a pressure release chamber (23). The pressure release chamber (23) is connected with a beverage tube (24) of the tapping device (13) to the tap thereof. A down movement of the tap opens the beverage flow and an up movement to a upright position of the handle of the tap of the tapping device (13) stops the beverage flow. The beverage is cooled, since the beverage tube (24) is surrounded by a coolant (25), such as ice water.

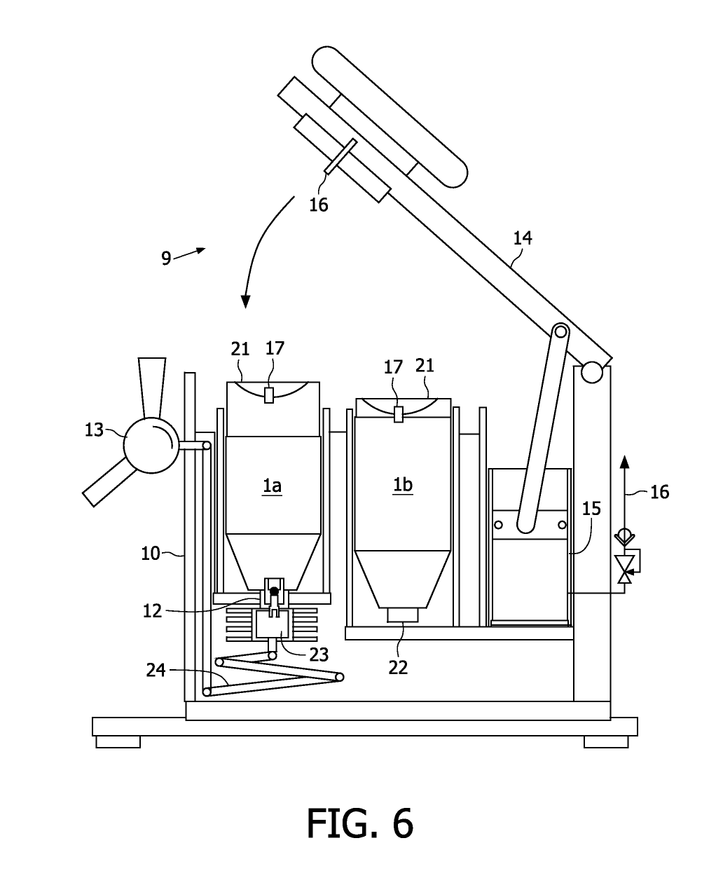

FIG. 6 shows a beverage carousel dispensing device as shown in FIG. 5, with an open lid (14).

Preferably at least one forward and backward movement of the top cover (14) actuates a gas pressure stroke from the pump (15) sufficient to empty a beverage container (1a) connected therewith in one go.

FIG. 7 shows a top view of a circular arrangement of twenty beverage containers, depending on the size of the beverage dispensing device (13). A beverage dispensing device (13) as shown in FIGS. 4, 5 and 6 can be built to store for example up to 20 beverage containers. According to the present invention, it may be preferred that the maximum beverage content of said beverage containers is about 200 ml to 500 ml, preferably 330 ml, so that these beverage containers are for single use only.

The particular combinations of elements and features in the above detailed embodiments are exemplary only; the interchanging and substitution of these teachings with other teachings in this and the patents/appliances incorporated by reference are also expressly contemplated. As those skilled in the art will recognize, variations, modifications, and other implementations of that which is described herein may occur without their departing from the spirit and scope of the invention as claimed. Accordingly, the above description is by way of example only and is not intended to be limiting. The scope of the invention is defined in the following claims and the equivalents thereto. Furthermore, reference signs used in the description and claims do not limit the scope of the invention as claimed.

1. A self-emptying beverage container (1) containing a beverage (2), wherein the self-emptying beverage container (1) comprises:
a beverage outlet opening (4);
a compressed gas (5) in an amount that is sufficient to drive out the beverage (2) inside the self-emptying beverage container (1) in one go; wherein the maximum filling level of the beverage (2) of the self-emptying beverage container (1) is ≦90 Vol.-% of the total inner volume (6) of the self-emptying beverage container (1).

2. The self-emptying beverage container (1) according to claim 1, wherein the amount of gas (5) inside the self-emptying beverage container (1), calculated on the basis of atmospheric pressure and room temperature, is at least ≧1.1 and ≦10, preferably ≧1.3, further preferably ≧1.5, more preferably ≧2 and most preferably ≧3 times as much compared to the total inner volume (6) of said self-emptying beverage container (1).

3. The self-emptying beverage container (1) according to claim 1, wherein the pressure of the compressed gas (5) at 23° C. inside the self-emptying beverage container (1) is at least 1.5 bars, preferably ≧2 bars and ≦10 bars, more preferably ≧3 bars and ≦7 bars and most preferably ≧4 bars and ≦5 bars.

4. The self-emptying beverage container (1) according to claim 1, wherein the volume of the compressed gas (5) inside the self-emptying beverage container (1) is less than 50 vol.-% and ≧10 vol.-%, preferably ≦40 vol.-% and ≧15 vol.-%, more preferably ≦35 vol.-% and ≧20 vol.-% and most preferably ≦30 vol.-% and ≧25 vol.-%, based on the total inner volume of the self-emptying beverage container (1).

5. The self-emptying beverage container (1) according to claim 1, wherein the compressed gas (5) is in direct contact with the beverage and/or the compressed gas (5) is inside a capsule (7) enclosed in the inner volume of said self-emptying beverage container, whereby the capsule (7) releases a compressed gas stored inside said capsule (7) by the time the gas pressure inside the self-emptying beverage container falls below a defined gas pressure limit, which is above atmosphere pressure.

6. The self-emptying beverage container (1) according to claim 1, wherein the self-emptying beverage container (1) comprises a gas pressure inlet opening (17) through which a compressed gas can be inserted into the self-emptying beverage container (1), preferably the gas pressure inlet opening (17) and the beverage outlet opening (4) being located opposite each other on the top (21) or bottom (22) of said self-emptying beverage container (1), more preferably the gas pressure inlet opening (17) and the beverage outlet opening (4) being located near the top (21) or bottom (22) of said self-emptying beverage container (1) and most preferably the gas pressure inlet opening (17) and the beverage outlet opening (4) being part of the same valve (21).

7. The self-emptying beverage container (1) according to claim 1, wherein the self-emptying beverage container (1) comprises a beverage delivering tube (3) with an outlet opening (8) arranged at least inside the beverage and in contact with the beverage outlet opening (4) arranged on top of the self-emptying beverage container (1) through which the beverage is driven out, preferably the beverage delivering tube (3) extending at least from the top or near the bottom (22) of said self-emptying beverage container and preferably a section of the delivering tube (3) extending outwards.

8. The self-emptying beverage container (1) according to claim 1, wherein the beverage outlet opening (4) and/or the outlet opening (8) of the beverage delivering tube (3) comprise an adapter (18) and/or a valve (18) to which the tapping device (13) can be connected for delivering the beverage.

9. The self-emptying beverage container (1) according to claim 1, wherein the self-emptying beverage container (1) comprises beverage, preferably a carbonated beverage and most preferably beer, in an amount of ≧200 ml to ≦10 l, preferably ≧300 ml to ≦6 l, further preferably ≧500 ml to ≦5 l and more preferably ≧700 ml to ≦3 l.

10. The self-emptying beverage container (1) according to claim 1, wherein the compressed gas is air, nitrogen, carbon dioxide and/or a noble gas, and preferably a mixture of at least two different gases.

11. A beverage carousel dispensing device (9) with a housing (10) and a holding element (11) located within the housing (10) for receiving at least two beverage containers (A1) comprising non self-emptying beverage containers (A2) and/or self-emptying beverage containers (1) according to claim 1, wherein the beverage carousel dispensing device (9) comprises a tapping device (13) for dispensing beverage from the beverage container (A1) and a cooling element, so that the housing (10) functions as a chiller for cooling the beverage.

12. The beverage carousel dispensing device (9) according to claim 11, wherein the holding element (11) is arranged to receive at least 4 to 10 beverage containers, preferably self-emptying beverage containers (1).

13. The beverage carousel dispensing device (9) according to claim 11, wherein the holding element (11) can be actuated to transport a selected beverage container, preferably a self-emptying beverage container (1), to a predetermined connecting tapping point (12) inside the housing (10) to be connected to the tapping device (13), so that a first beverage container (1a) can be replaced by a second beverage container (1b) at the connecting tapping point (12).

14. The beverage carousel dispensing device (9) according to claim 11, wherein the tapping device comprises an adapter (18), preferably a valve element (18), for connecting the beverage container (1) with the tapping device (13), the tapping device (13) preferably having a knob (19) for moving the adapter (18) of the tapping device (13) up and down.

15. The beverage carousel dispensing device (9) according to claim 11, wherein the tapping device (13) comprises a pressure release chamber (23) and/or a beverage tube (24).

16. The beverage carousel dispensing device (9) according to claim 11, wherein the holding element (11) is rotatable to transport the selected self-emptying beverage container (1) to the predetermined connecting tapping point (12) inside the housing (10).

17. The beverage carousel dispensing device (9) according to claim 11, wherein the beverage carousel dispensing device (9) comprises a pressure pump (15), which can be actuated manually to increase the gas pressure inside the self-emptying beverage container (1) at the connecting tapping point (12), the pressure line (16) of the pump (15) being connected with the gas pressure inlet opening (17) of the beverage container (1a) at the connecting tapping point (12).

18. The beverage carousel dispensing device (9) according to claim 11, wherein the beverage carousel dispensing device (9) comprises a top cover (14) and/or door (14), which is connected with the pump (15), an opening or closing of the top cover (14) and/or door (14) actuating the pump (12), preferably at least one forward and backward-movement of the top cover (14) and/or door (14) actuating a gas pressure stroke from the pump sufficient to empty a beverage container (1) connected therewith in one go.
